(19) United States
(12) Patent Application Publication
(10) Pub. No.: US 2013/0272483 A1
(43) Pub. Date: Oct. 17, 2013

(54) LOWER END PLUG WITH TEMPERATURE REDUCTION DEVICE AND NUCLEAR REACTOR FUEL ROD INCLUDING SAME

(71) Applicant: BABCOCK & WILCOX MPOWER, INC., Charlotte, NC (US)

(72) Inventors: William E. Russell, Lynchburg, VA (US); Earl B. Barger, Goode, VA (US); Roger D. Ridgeway, Lynchburg, VA (US); Jeffrey W. Austin, Evington, VA (US); D. MIchael Minor, Lynchburg, VA (US); Jeffrey T. Lee, Forest, VA (US)

(73) Assignee: BABCOCK & WILCOX MPOWER, INC., Charlotte, NC (US)

(21) Appl. No.: 13/677,396

(22) Filed: Nov. 15, 2012

Related U.S. Application Data
(60) Provisional application No. 61/625,367, filed on Apr. 17, 2012.

(51) Int. Cl. G21C 3/10

(52) U.S. Cl. CPC G21C 3/10
USPC 376/451; 228/101

(57) ABSTRACT

A pedestal plug is sized to fit into a cladding of a nuclear fuel rod. A lower end plug is sized and shaped to plug the lower end of the nuclear fuel rod. One of the pedestal plug and the lower end plug includes a protrusion and the other of the pedestal plug and the lower end plug includes a hollow region into which the protrusion fits. In one embodiment the pedestal plug is a hollow cylindrical pedestal plug and the protrusion is disposed on the lower end plug. The protrusion disposed on the lower end plug suitably press fits into the hollow cylindrical pedestal plug. In a method of assembling a fuel rod of a nuclear reactor, the pedestal plug and the lower end plug are press fit together, and after the press fitting the lower end plug is welded to a cladding of the fuel rod with the pedestal plug disposed inside the cladding.

### RELATED APPLICATIONS

This application claims the benefit of U.S. Provisional Application No. 61/625,367 filed Apr. 17, 2012. U.S. Provisional Application No. 61/625,367 filed Apr. 17, 2012 is hereby incorporated by reference in its entirety.

### BACKGROUND

The following relates to the nuclear reactor arts, nuclear power generation arts, nuclear fuel arts, and related arts.

In a typical nuclear reactor, for example a pressurized water type reactor (PWR), a nuclear reactor core is disposed in a pressure vessel containing primary coolant (usually water). The reactor core generally includes a large number of fuel assemblies each of which includes top and bottom end fittings or nozzles with a plurality of elongated transversely spaced guide tubes extending longitudinally between the end fittings, and a plurality of transverse support grids (also called spacer grids) axially spaced along and attached to the guide tubes. Each fuel assembly includes a plurality of elongated fuel elements, also called fuel rods, transversely spaced apart from one another and from the guide tubes and supported by the transverse spacer grids between the top and bottom end fittings. The fuel rods each contain fissile material, and an array of such fuel assemblies are arranged to provide a radioactive nuclear reactor core with a designed volume of fissile material. The primary coolant flows upwardly through the core in order to provide heat sinking, and in so doing the primary coolant extracts heat generated in the core which can be used for the production of power. Various arrangements can be used to extract useful power from the heated primary coolant. For example, in a boiling water reactor (BWR) the primary coolant is allowed to boil and the primary coolant steam is piped out of the pressure vessel to drive a turbine. In PWR designs, the primary coolant remains in a subcooled liquid state and is piped out of the pressure vessel to boil secondary coolant in external steam generators, or alternatively a steam generator is disposed in the pressure vessel (i.e., an integral PWR) and the secondary coolant is piped into the internal steam generators.

In general, each fuel rod includes multiple nuclear fuel pellets containing fissile material loaded into a cladding tube, with end plugs secured to opposite (e.g., bottom and top) ends of the tube. It is possible for a nuclear fuel rod to generate temperatures higher than would be safe for the zirconium alloy lower end plug, potentially causing failure of the lower end plug and breach of the fuel rod. Traditional boiling water reactors (BWR) have kept temperatures lower at the bottom of the fuel through several techniques such as providing a 6 inch “blanket” of non-enriched fuel at the bottom of the fuel rods. Some BWRs also have control rods that enter the core from the bottom, which reduces power at the bottom of the core. Generally, such designs limit the maximum heat flux to less than 2 kw/ft, which prevents excessively high temperature at the lower end plug.

This approach is not applicable to PWR designs employing control rods entering from above the reactor core, such as a small modular reactor (SMR). Integral PWR designs are typically taller than traditional PWRs because the pressure vessel contains internal steam generators that add to the vessel height. Because of this, traditional BWR and PWR designs have a more mild axial shape at the bottom of the core than SMRs. One contemplated SMR design of the PWR variety has control rods that enter the core from the top in combination with fuel enrichments on the order of about 5% at the bottom of the fuel. It has been determined that this combination creates the potential for high heat flux at the bottom of the fuel. Analysis of anticipated rod pattern maneuvers suggests the potential for a heat flux as high as 9 kw/ft at the bottom of the fuel, resulting in temperatures in excess of 1400° F. Even during steady state operation, heat flux as low as 3 kw/ft would result in temperatures higher than the 750° F. design limit criteria.

Some PWR designs have employed a spacer between the fuel pellets and the lower end plug. These spacers are typically a solid cylinder of a ceramic material such as Al₂O₃, which is placed into the rod at time of fuel pellet loading. Because there are many fuel rods (e.g., more than one hundred rods per fuel assembly and 10,000 or more rods in the reactor core of some designs), there is a non-negligible likelihood that the spacer may be inadvertently omitted in one or more fuel rods, potentially resulting in fuel failure.

Disclosed herein is an approach that provides benefits such as reducing or eliminating the possibility of excess temperature on the lower end plug and reducing or eliminating the likelihood of human error in assembling the fuel rods.

### SUMMARY

In accordance with one aspect, a pedestal plug is sized to fit into a cladding of a nuclear fuel rod. A lower end plug is sized and shaped to plug the lower end of the nuclear fuel rod. One of the pedestal plug and the lower end plug includes a protrusion and the other of the pedestal plug and the lower end plug includes a hollow region into which the protrusion fits. In one embodiment the pedestal plug is a hollow cylindrical pedestal plug and the protrusion is disposed on the lower end plug. The protrusion disposed on the lower end plug suitably press fits into the hollow cylindrical pedestal plug.

In accordance with another aspect, a method of assembling a fuel rod of a nuclear reactor is disclosed. A pedestal plug and a lower end plug are connected. After the connecting, the lower end plug is welded to a cladding of the fuel rod with the pedestal plug disposed inside the cladding. In one embodiment the pedestal plug and the lower end plug are connected by press fitting a protrusion on one of the pedestal plug and the lower end plug into a hollow region of the other of the pedestal plug and the lower end plug. The method may further include loading fuel pellets comprising fissile material into the cladding of the fuel rod.

In accordance with another aspect, a lower end plug comprises a solid cylindrical element having a tapered first end and an opposite second end with a protrusion or blind hole surrounded by an annular surface of reduced diameter compared with the cylindrical portion of the lower end plug.

### BRIEF DESCRIPTION OF THE DRAWINGS

The invention may take form in various components and arrangements of components, and in various process operations and arrangements of process operations. The drawings are only for purposes of illustrating preferred embodiments and are not to be construed as limiting the invention.

FIG. 1 is an illustrative nuclear reactor of the pressurized water reactor (PWR) variety with internal steam generators (integral PWR).

FIG. 2 is a cross-sectional view of the nuclear reactor of FIG. 1.

FIG. 3 is a perspective isolation view of a pedestal plug as disclosed herein.

FIG. 4 is a cross-sectional view of a fuel rod including the pedestal plug of FIG. 3 and a lower end plug configured to mate with the pedestal plug.

FIG. 5 is perspective isolation view of the lower end plug of the fuel rod of FIG. 4.

FIG. 6 shows a simulated thermal map of the fuel rod of FIG. 4 during reactor operation.

FIG. 7 is an alternative embodiment of the pedestal plug.

FIG. 8 is an alternative embodiment of the lower end plug which is configured to mate with the pedestal plug of FIG. 7.

### DETAILED DESCRIPTION OF THE PREFERRED EMBODIMENTS

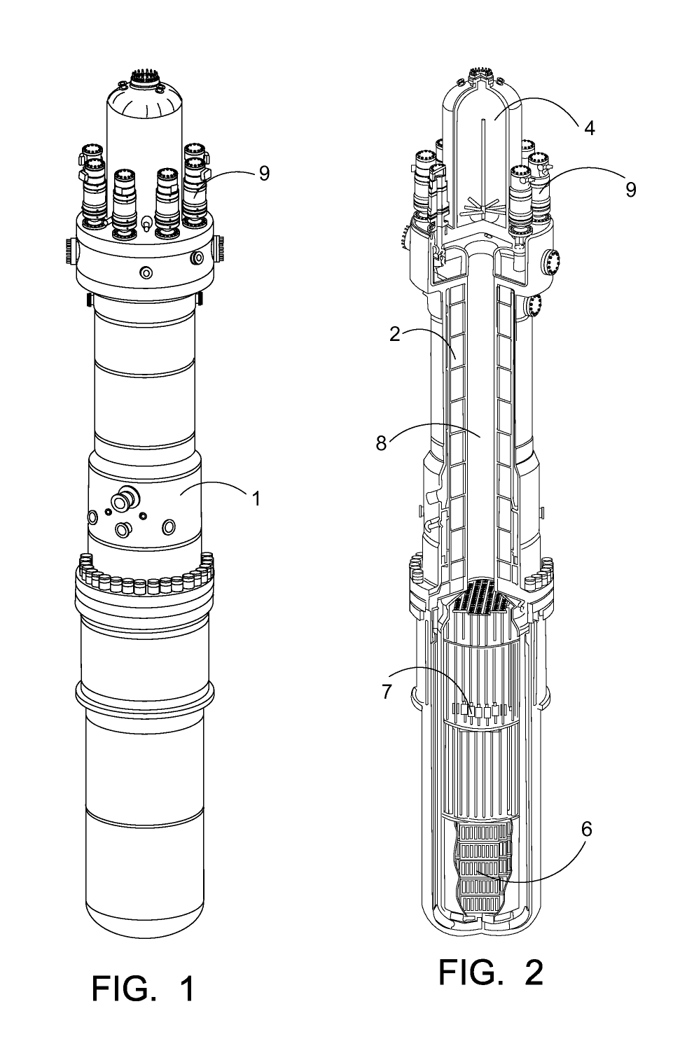

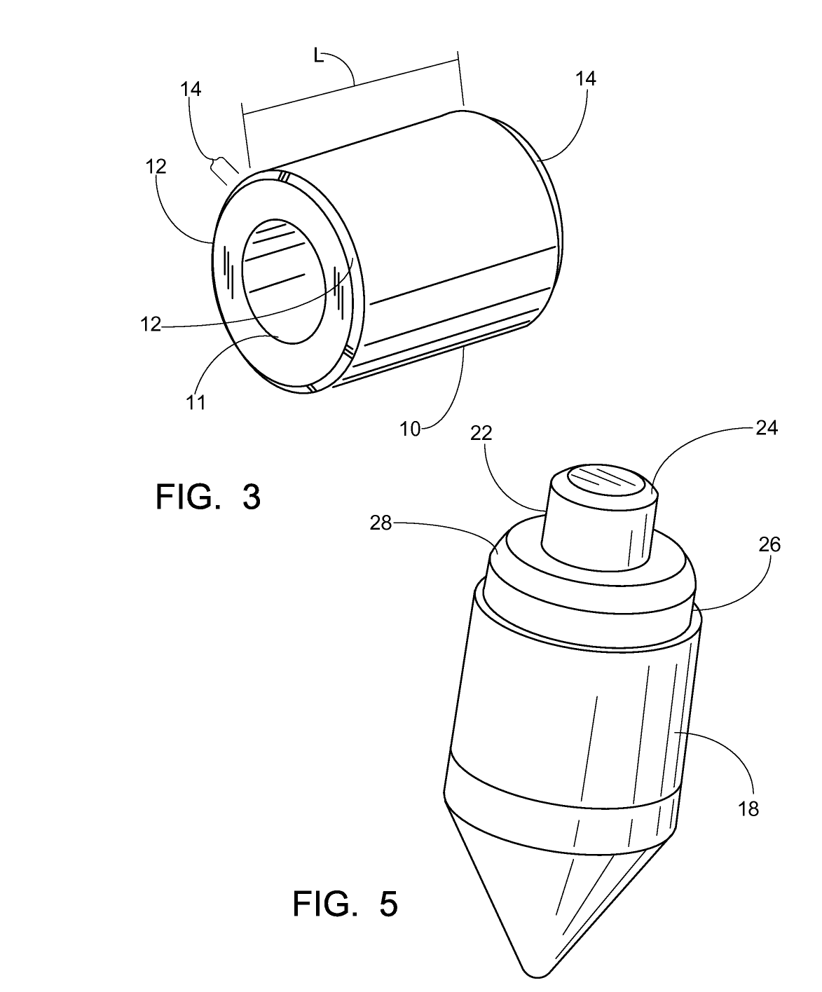

With reference to FIGS. 1 and 2, an illustrative nuclear reactor 1 of the pressurized water reactor (PWR) variety is shown. The illustrative PWR 1 employs internal steam generators 2 (see FIG. 2) located inside the pressure vessel (i.e., integral PWR 1), but embodiments with the steam generators located outside the pressure vessel (i.e., a PWR with external steam generators) are also contemplated. The illustrative PWR 1 includes an integral pressurizer 4, but a separate external pressurizer may instead be employed. The disclosed lower end plug configurations are disposed at the bottoms of fuel rods that make up the nuclear reactor core 6 seen in FIG. 2. The illustrative PWR includes internal control rod drive mechanisms (internal CRDMs) 7; however, external CRDMs are also contemplated. Circulation of primary coolant in the illustrative PWR 1 is upward through the reactor core 6 and through a central riser 8 (i.e., the “hot leg”), and back down to below the reactor core 6 via a downcomer annulus defined between the central riser 8 and the pressure vessel (i.e., the “cold leg”). The primary coolant circulation is assisted or driven by reactor coolant pumps (RCPs) 9 which are externally mounted near the pressurizer 4 in the illustrative PWR 1, but which may be more generally located elsewhere, or may be canned internal RCPs located inside the pressure vessel. It is also contemplated to omit the RCPs entirely and to rely upon natural circulation of primary coolant driven by heating from the reactor core.

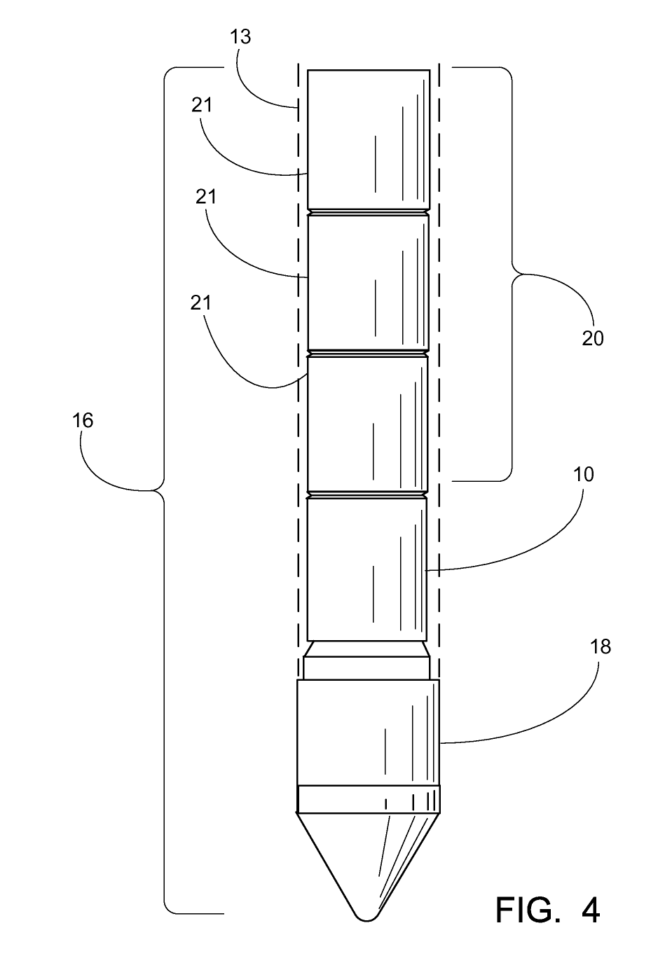

With reference to FIGS. 3-5, a pedestal plug 10, shown in FIG. 3, is the shape of a hollow cylinder with an inside diameter 11 that matches the pellet inside diameter. The outside diameter 12 of the pedestal plug 10 is preferably less than the inside diameter of the (hollow cylindrical) cladding 13 of the fuel rod (see FIG. 4), and optional chamfering 14 on the ends of the pedestal plug 10 enables the outside diameter 12 to match the chamfered outside diameter of the fuel pellet. The pedestal plug 10 has a length L selected to be long enough to reduce the maximum temperature of the lower end plug 18 (see FIG. 4) during reactor operation to an acceptably low value. In simulations, a suitable length has been found to be comparable with or equal to the length of a fuel pellet 21 (see FIG. 4).

In the assembled lower end of the fuel rod 16 (shown in FIG. 4), the pedestal plug 10 of FIG. 3 connects with a (modified) lower end plug 18 (see also FIG. 5). As seen in FIG. 4, the fuel column 20 (i.e., the set of fuel pellets 21 loaded into the cladding 13) contacts the pedestal plug 10 with a large or maximum surface area enabling a flat geometry for contact. Similarly, the pedestal plug 10 contacts the lower end plug 18 with maximum surface area at the bottom. The pedestal plug 10 is secured to the lower end plug 18 by a protrusion 22 (see FIG. 5) on the lower end plug 18 that is slightly larger in diameter than the lumen (i.e., inner diameter 11) of the pedestal plug 10. The mated geometry between the lower end plug 18 and the pedestal plug 10 allows a “press fit” that is strong enough to hold the components together. The press fit can be relied upon by itself to maintain the connection between the pedestal plug 10 and the lower end plug 18, or alternatively a weld or other fastening mechanism can be employed with the press fit relied upon to hold the pieces together during the welding or other fastening process. The illustrative protrusion 22 includes a chamfered edge 24 (referred to as the protrusion chamfered edge to distinguish it from the chamfer 14 of the pedestal plug 10) to facilitate the press fit. The illustrative end plug 18 further includes a narrowed-diameter “collar” 26 to facilitate welding the end plug to the cladding. In some embodiments, the collar 26 may also have a chamfer 28 (referred to as the collar chamfer 28 to distinguish it from the chamfer on the pedestal and the protrusion chamfered edge).

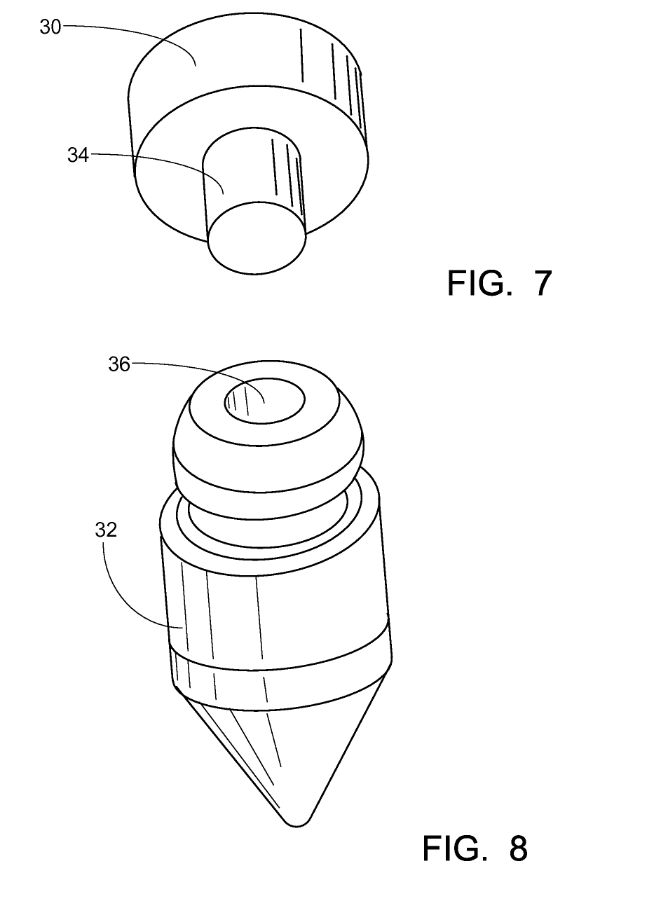

The illustrative lower end plug 18 best seen in FIG. 5 is a solid (that is, not hollow) cylindrical element having a tapered first (i.e. lower) end and an opposite second (i.e. upper) end configured to (1) connect with the pedestal plug and (2) plug the lower end of the cladding 13 of the fuel rod. For the purpose of connecting with the pedestal plug, the second (i.e. upper) end of the illustrative lower end plug 18 includes the protrusion 22. Alternatively, a hollow region can serve this purpose (see the alternative lower end plug embodiment of FIG. 8) when the pedestal plug has a mating protrusion (see the alternative pedestal plug embodiment of FIG. 7). For the purpose of plugging the lower end of the cladding 13 of the fuel rod, the second (i.e. upper) end of the illustrative lower end plug 18 includes the narrowed-diameter “collar” 26 to facilitate welding the lower end plug 18 to the lower end of the cladding. More generally, the contact region 26 for performing the function of plugging the cladding comprises an annular surface of reduced diameter compared with the cylindrical portion of the lower end plug, but the reduced diameter is still of large enough so that the annular surface surrounds the protrusion or blind hole that mates with the pedestal plug.

The cylindrical portion of the lower end plug 18 is suitably of the same diameter as the outer diameter of the fuel rod cladding 13, so that the plugged lower end of the fuel rod (FIG. 4) has a constant cylinder diameter up to the tapered first (i.e. lower) end of the lower end plug. As the hollow cylindrical pedestal plug 10 fits inside the rod cladding 13, it follows that the pedestal plug 10 has an outer diameter that is smaller than the outer diameter of the cylindrical portion of the lower end plug 18.

In the illustrated embodiment of FIGS. 3-5, the press-fit connected pedestal plug/lower end plug assembly 10, 18 is continuously rotationally symmetric about the axis of the fuel rod. This rotational symmetry, in combination with the outside diameter 12 of the hollow cylindrical pedestal plug 10 being less than the inside diameter of the cladding 13 of the fuel rod, ensures that the pedestal plug 10 does not contact the cladding 13. This lack of contact reduces the effect of the cladding 13 a thermal shunt around the pedestal plug 10, thus increasing the thermal isolation of the lower end plug 18 provided by the pedestal plug 10.

In a suitable configuration the lower end plug 18 (FIG. 5) is made of zircalloy and the pedestal plug 10 (FIG. 3) is made of stainless steel. Other materials are also contemplated, such as other metals, e.g. Inconel, a nickel-steel alloy, or so forth. If the pedestal plug 10 is made of stainless steel or another metal, then it is suitably manufactured by machining, casting, forging, or another technique.

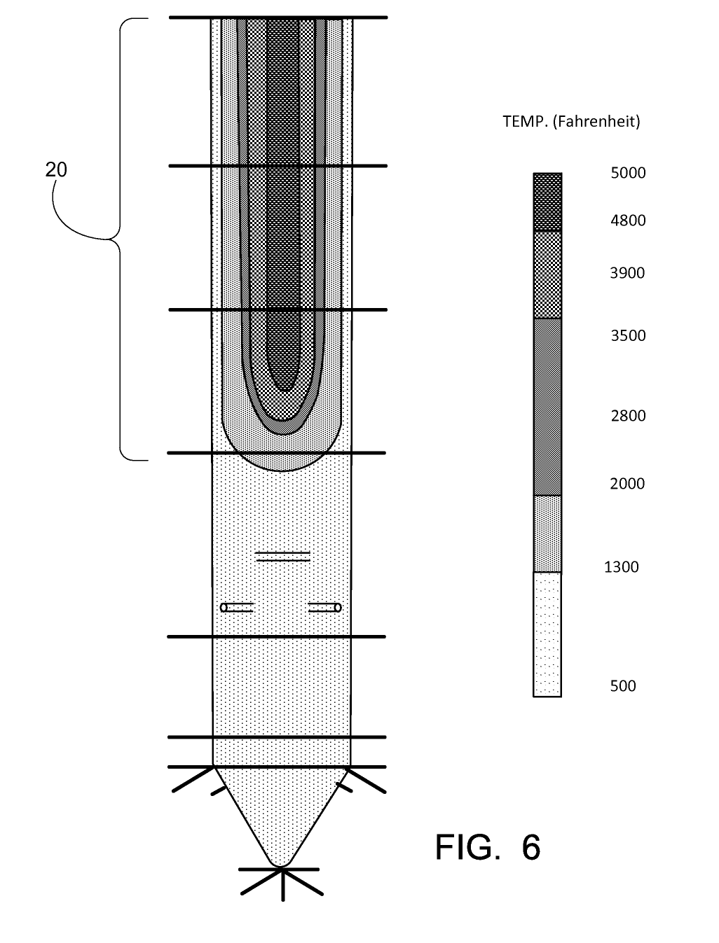

With reference to FIG. 6, finite element modeling of the embodiment of FIGS. 3-5 was performed to assess the lower end plug temperature reduction. The finite element modeling indicates that the maximum temperature in the lower end plug 18 is as low as 633° F. even with the fuel column 20 operating at a design limit of 8 kw/ft (for the integral PWR design substantially as shown in FIGS. 1 and 2). Furthermore, it can also be shown that the fuel can operate at over 20 kw/ft in the bottom node before any part of the lower end plug 18 reaches the design temperature criteria of 750° F. This large thermal safety margin is expected to prevent undesirably high temperatures at the lower end plug for the credible space of contemplated reactor operation, fuel pellet enrichment, and control rod pattern maneuvers.

One aspect of the disclosed lower fuel rod design that contributes to achieving this temperature reduction is the hollow center of the pedestal plug 10 (see FIG. 3). The hollow center allows the plug to avoid contact with the hottest part of the bottom fuel pellet, while still providing a flat top that is capable of supporting the weight of the entire fuel stack 20 and providing the desired temperature distribution.

The disclosed configuration also has the advantage of reducing or eliminating the likelihood of human error in assembling the fuel rods. In existing designs that employ a “dummy” or low-enriched fuel pellet adjacent the lower end plug, this “spacer” is of similar size, shape, and appearance to the standard fuel pellets that are loaded into the fuel rod cladding. It is therefore possible to forget to load this dummy or low-enriched pellet, or to inadvertently load an enriched fuel pellet in place of the intended spacer. Since each fuel assembly typically includes dozens or hundreds of fuel rods, and the overall reactor core includes dozens or more fuel assemblies, the likelihood of such human error occurring is multiplied.

The disclosed approach prevents this possibility by connecting the pedestal plug 10 (FIG. 3) to the lower end plug 18 (FIG. 5) prior to the loading and welding process. This has the added benefit of reducing the complexity of the rod loading process and eliminating an extra part (the dummy or low-enriched ending pellet) that otherwise has to be tracked, handled, and installed during the rod loading process. Furthermore, if the pedestal plug 10 is made of stainless steel or another metal, then the pedestal plug 10 is visually distinct from the fuel pellets 21. In contrast, a ceramic dummy pellet appears similar or identical to the ceramic fuel pellets, increasing the likelihood of human error. Still further, it is contemplated to employ a robotic welding process for welding the end plug 18 with the cladding 13 that requires the presence of the pedestal plug on the lower end plug, otherwise welding would stop.

Another advantage is improved welding robustness. For good welding, it is best that the metal-metal contact of items next to the welding location be similar and consistent during the weld. While a separate spacer would be non-symmetric by having a metal-metal contact on one side due to gravity, the opposite side would have a wider gap. The disclosed configuration ensures non-contact for the full 360° rotation of the weld, resulting in improved weld consistency and predictability.

Another advantage is reduced manufacturing cost due to the geometry of the pedestal plug (standard cylinder, one centered through-hole, and chamfering). The pedestal plug 10 is expected to have a production cost well below that of a Al₂O₃ “dummy” spacer pellet, resulting in significant cost reduction. For a fuel assembly utilizing the pedestal plug, cost saving up to about 90% may be achieved over that of utilizing a Al₂O₃ “dummy” spacer pellet (estimated based on 2011 cost), thereby significantly reducing overall reload cost.

Another advantage is an increase in fuel rod plenum. During the irradiation process of a fuel rod, gases are produced within the fuel rod. These gases can limit the length of time a rod can be used. To address this problem, geometric voids in the fuel rod (sometimes known as plenum) are optionally added. Because the pedestal plug 8 is hollow (see FIG. 3), additional plenum is created.

Another advantage is an increase in active fuel length and resulting reactor power. Because of effective temperature reduction, the pedestal plug 18 can be made shorter than a ceramic spacer pellet while still meeting thermal design criteria. In one alternative design, it is expected that an additional fuel pellet could be added to every rod in the core when the pedestal plug was about 3/16″ in length. This would result in an increase in uranium and several additional days of power on a multiple year fuel cycle.

Yet another advantage is improved material robustness and expected enhanced customer acceptance. The use of stainless steel as a reactor component has a proven track record for decades and is widely accepted as an allowed reactor component material, even in the fuel bundle.

With reference to FIGS. 7 and 8, an alternative pedestal plug 30 (FIG. 7) and mating alternative lower end plug 32 (FIG. 8) is shown. In this alternative design, the protrusion 34 is located on the pedestal plug 30 (see FIG. 7) and engages a hollow portion 36 of the lower end plug 32 (FIG. 8).

In both the illustrative embodiment of FIGS. 3-5 and the illustrative embodiment of FIGS. 7 and 8, the protrusion 22, 34 and the hollow region (namely the lumen of the hollow cylindrical pedestal plug 10 or the blind hole 36 of the lower end plug 32) have continuous rotational symmetry. However, these mating features can have other cross-sectional configurations, such as a square cross-section (providing four-fold rotational symmetry).

The preferred embodiments have been illustrated and described. Obviously, modifications and alterations will occur to others upon reading and understanding the preceding detailed description. It is intended that the invention be construed as including all such modifications and alterations insofar as they come within the scope of the appended claims or the equivalents thereof.

1. An apparatus comprising:
a pedestal plug sized to fit into a cladding of a nuclear fuel rod; and
a lower end plug sized and shaped to plug the lower end of the nuclear fuel rod;
wherein one of the pedestal plug and the lower end plug includes a protrusion and the other of the pedestal plug and the lower end plug includes a hollow region into which the protrusion fits.

2. The apparatus of claim 1 wherein the pedestal plug is a hollow cylindrical pedestal plug and the protrusion is disposed on the lower end plug.

3. The apparatus of claim 2 wherein the protrusion disposed on the lower end plug press fits into the hollow cylindrical pedestal plug.

4. The apparatus of claim 3 wherein the protrusion disposed on the lower end plug is press fit into the hollow cylindrical pedestal plug, and the apparatus further comprises:
said nuclear fuel rod comprising said cladding, the lower end plug plugging the lower end of the nuclear fuel rod with the hollow cylindrical pedestal plug disposed inside the cladding.

5. The apparatus of claim 4 wherein the nuclear fuel rod further includes a stack of fuel pellets comprising fissile material disposed inside the cladding.

6. The apparatus of claim 5 wherein the hollow cylindrical pedestal plug has a height equal to the height of a fuel pellet of the stack of fuel pellets.

7. The apparatus of claim 5 wherein pedestal plug has a diameter which is approximately the same as a diameter of fuel pellets.

8. The apparatus of claim 5 wherein hollow cylindrical pedestal plug has the same size and shape as the fuel pellets of the stack of fuel pellets.

9. The apparatus of claim 7 wherein the end of the hollow cylindrical pedestal plug that is distal from the lower end plug makes contact with the lowermost fuel pellet of the stack of fuel pellets.

10. The apparatus of claim 4 wherein the outer diameter of the hollow cylindrical pedestal plug is less than the inner diameter of the cladding and the hollow cylindrical pedestal plug does not contact the cladding.

11. The apparatus of claim 2 wherein the hollow cylindrical pedestal plug has chamfered circular ends.

12. The apparatus of claim 1 wherein the pedestal plug includes the protrusion and the lower end plug includes the hollow region comprising a blind hole.

13. The apparatus of claim 1 wherein the pedestal plug is a metal element.

14. The apparatus of claim 1 wherein the pedestal plug is a stainless steel element.

15. The apparatus of claim 1 wherein the pedestal plug is sized to fit inside the cladding without contacting the inner surface of the cladding.

16. A method of assembling a fuel rod of a nuclear reactor, the method comprising:
connecting a pedestal plug and a lower end plug; and
after the connecting, welding the lower end plug to a cladding of the fuel rod with the pedestal plug disposed inside the cladding.

17. The method of claim 16 wherein the connecting comprises press fitting a protrusion on one of the pedestal plug and the lower end plug into a hollow region of the other of the pedestal plug and the lower end plug.

18. The method of claim 16 further comprising:
loading fuel pellets comprising fissile material into the cladding of the fuel rod.

19. An apparatus comprising:
a lower end plug comprising a solid cylindrical element having a tapered first end and an opposite second end with a protrusion or blind hole surrounded by an annular surface of reduced diameter compared with the cylindrical portion of the lower end plug.

20. The apparatus of claim 19 wherein the second end of the lower end plug has a protrusion surrounded by said annular surface of reduced diameter compared with the cylindrical portion of the lower end plug.

21. The apparatus of claim 20 further comprising:
a hollow cylindrical pedestal plug having a lumen into which the protrusion of the second end of the lower end plug press fits and having an outer diameter that is smaller than the outer diameter of the cylindrical portion of the lower end plug.

22. The apparatus of claim 21 further comprising:
a fuel rod including a hollow cylindrical cladding wherein the annular surface of reduced diameter compared with the cylindrical portion of the lower end plug is sized to plug the lower end of the hollow cylindrical cladding.
